(19) United States
(12) Patent Application Publication
(10) Pub. No.: US 2026/0034860 A1
(43) Pub. Date: Feb. 5, 2026

(54) HVAC MODULE INCLUDING A RAM AIR COMPENSATION DOOR

(71) Applicant: MAHLE International GmbH, Stuttgart (DE)

(72) Inventors: Edward Wolfe, Clarence Ctr., NY (US); Bailey Reid, Lockport, NY (US); Richard Baranowski, Lake View, NY (US)

(21) Appl. No.: 18/792,225

(22) Filed: Aug. 1, 2024

(51) Int. Cl. B60H 1/26

(52) U.S. Cl. CPC B60H 1/26

(57) ABSTRACT

A valve assembly for a heating, ventilation, and air conditioning (HVAC) module may include a valve housing, an adjustable valve, an adjustable compensation door, and an actuator. The valve housing may include an inlet cowl. The valve may be disposed in the valve housing. The compensation door may be disposed in the inlet cowl upstream of the valve. The actuator may be connected to the compensation door. The actuator may be in fluid communication with the inlet cowl and may adjust the compensation door based on an air pressure in the inlet cowl.

### TECHNICAL FIELD

The present disclosure generally relates to heating, ventilation, and air conditioning (HVAC) modules that may, for example, be used in connection with vehicles.

### BACKGROUND

Vehicles commonly have HVAC systems and/or modules for controlling the climate within the vehicle cabin or another internal space and/or area of the vehicle by providing heated air and/or cooled air into the vehicle cabin. Some HVAC system and/or module designs include a housing with an external air inlet via which air outside the vehicle flows into the housing and a recirculation air inlet via which air from within the vehicle cabin flows into the housing. A valve within the housing may be operated to selectively block and/or prevent external air and/or recirculation air from flowing through the housing and being expelled from an outlet of the housing. When the vehicle is traveling at high rates of speed and a blower of the HVAC system is operated at a lower speed, an unintended and undesirable leakage of external air past the valve may occur due to an elevated and/or high air pressure in the corresponding region of the housing. The leakage of external air past the valve may, for example, result in hot or cold external air from outside of the vehicle leaking into the vehicle cabin and cause passenger discomfort. The elevated and/or high air pressure may also negatively impact and/or reduce the efficiency of the blower.

Accordingly, there is a need for an improved HVAC system and/or module that minimizes or eliminates one or more challenges or shortcomings of existing HVAC systems and/or modules.

### SUMMARY

A valve assembly for a heating, ventilation, and air conditioning (HVAC) module may include a valve housing, an adjustable valve, an adjustable compensation door, and an actuator. The valve housing may include an inlet cowl. The valve may be disposed in the valve housing. The compensation door may be disposed in the inlet cowl upstream of the valve. The actuator may be connected to the compensation door. The actuator may be in fluid communication with the inlet cowl and may adjust the compensation door based on an air pressure in the inlet cowl.

A valve assembly for a heating, ventilation, and air conditioning (HVAC) module may include a valve housing, an adjustable valve, an adjustable compensation door, and an actuator. The valve housing may define an internal space. The valve housing may include (i) a first inlet via which a first input air is flowable into a first intake region of the internal space, (ii) a second inlet via which a second input air is flowable into a second intake region of the internal space, and/or (iii) an airflow opening. The valve may be disposed in the valve housing between the first intake region and the second intake region. The valve may be adjustable about a first axis to selectively open and close the airflow opening with respect to the first intake region and the second intake region. The compensation door may be disposed in the first intake region of the valve housing. The actuator may be connected to the compensation door and may be configured to adjust the compensation door about a second axis based on an air pressure in the first intake region.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIGS. 1 and 2 are perspective, partially exploded views of an exemplary HVAC module including a valve assembly and a blower assembly;

FIG. 3 is a cross-sectional perspective view of the valve assembly of the HVAC module of FIG. 1 when the compensation door is in an inactive position and the valve is in a first position;

FIG. 4 is a cross-sectional perspective view of the valve assembly of the HVAC module of FIG. 1 when the compensation door is in an active position and the valve is in a second position; and

FIGS. 5 and 6 are cross-sectional perspective views through an exemplary actuator of the HVAC module of FIG. 1 when the plunger is in a retracted position (FIG. 5) and when the plunger is in an extended position (FIG. 6), respectively.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

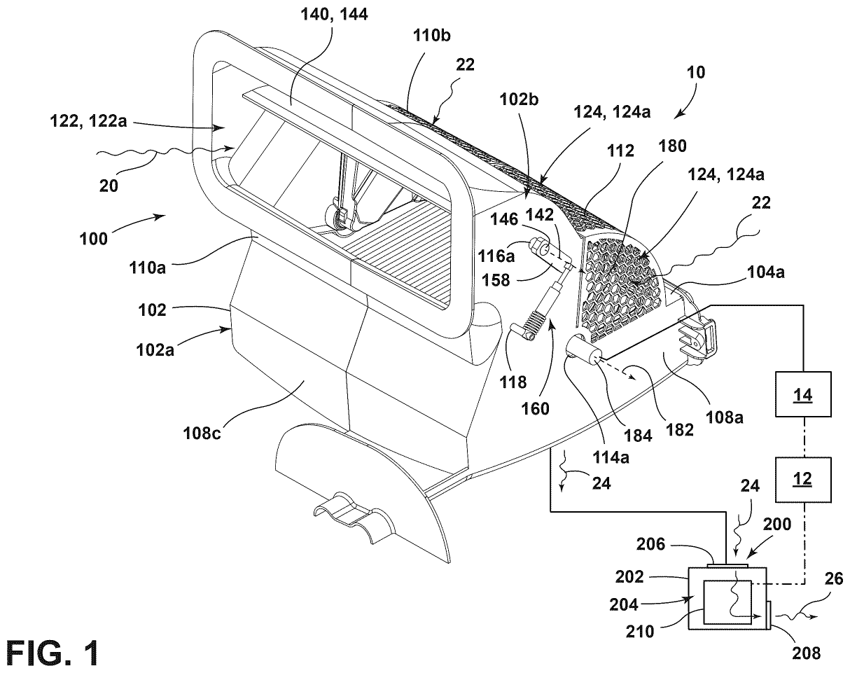

FIGS. 1-4 present a heating, ventilation, and air conditioning (HVAC) module 10 configured to receive air from one or more air sources (e.g., first and second air sources) and selectively output the received air, such as to one or more portions, areas (e.g., zones), and/or regions within a vehicle. Air (e.g., external air) from a first air source (e.g., an external space outside of the vehicle) may be considered and/or referred to as first input air 20. Air (e.g., recirculation air) from a second air source (e.g., an interior space and/or cabin of the vehicle) may be considered and/or referred to as second input air 22.

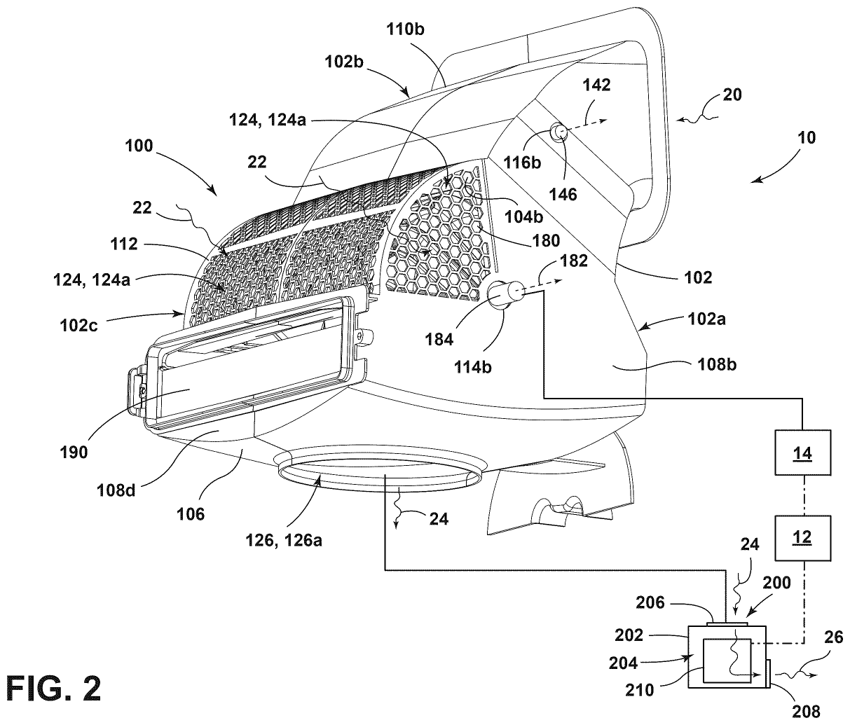

As generally illustrated in FIGS. 1 and 2, the HVAC module 10 includes a valve assembly 100, a blower assembly 200, and a controller 12. The valve assembly 100 and the blower assembly 200 are connected to one another and are in fluid communication with one another. The valve assembly 100 is configured to receive air 20, 22 from one or more air sources and selectively communicate the received air 20, 22 to the blower assembly 200 (e.g., as an airflow 24). The blower assembly 200 is configured to receive air (e.g., the airflow 24) from the valve assembly 100 and output that air to one or more structures, spaces, and/or destinations (e.g., as an output air 26). While shown as a simplified schematical representation, the blower assembly 200 includes a blower housing 202 with an internal space 204, an inflow opening 206, and an airflow outlet 208. The blower assembly 200 also includes a blower 210 arranged within the blower housing 202. The blower assembly 200 and/or the blower housing 202 are connected to the valve housing 102 (e.g., the end wall 106). The internal space 204 is in fluid communication with the internal space 120 of the valve housing 102 via the inflow opening 206 and the air outlet 126. The controller 12 is operatively connected (e.g., communicatively connected, electrically connected, and/or physically connected) to (i) the valve assembly 100 and/or one or portions/parts/elements thereof (e.g., motor 14) and (ii) the blower assembly 200 and/or one or portions/parts/elements thereof (e.g., blower 210). The controller 12 is configured to control and/or operate the HVAC module 10, the valve assembly 100, and/or the blower assembly 200.

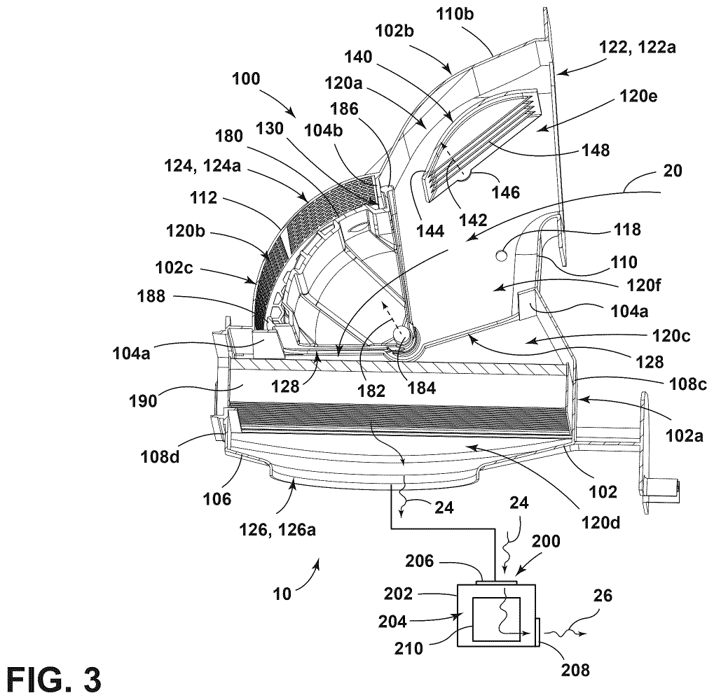

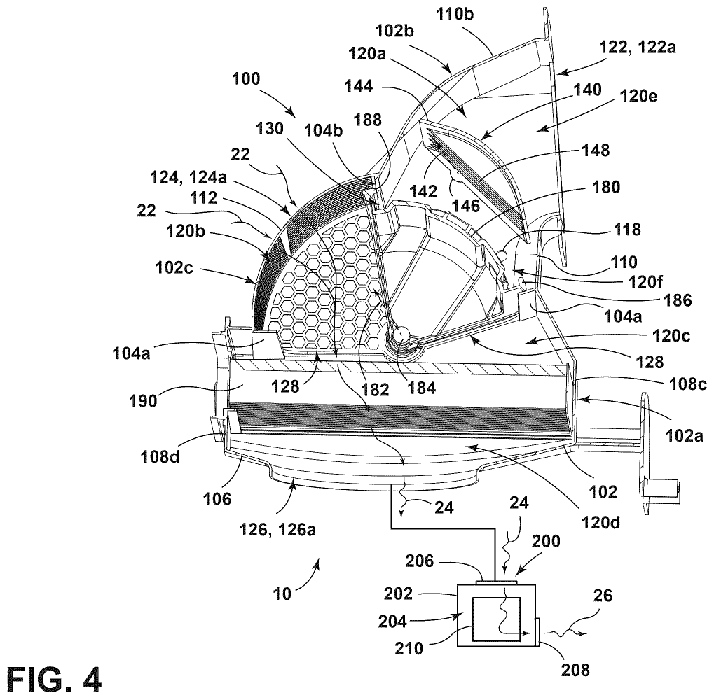

As generally illustrated in FIGS. 1-4 and described in further detail below, the valve assembly 100 includes a motor 14, a valve housing 102, a compensation door 140 (e.g., a ram air compensation door), an actuator 160, a valve 180, and a filter 190. The valve housing 102 includes a plurality of air inlets (e.g., a first and second inlet 122, 124), an air outlet 126, and an airflow opening 128 (see FIGS. 3, 4). The valve 180, the compensation door 140, and the filter 190 are arranged in an internal space 120 of the valve housing 102. The internal space 120 includes a first intake region 120a, a second intake region 120b, an unfiltered region 120c, and a filtered region 120d. Air (e.g., first input air 20 and/or external air) from a first air source is flowable into the first intake region 120a via the first inlet 122. Air (e.g., second input air 22 and/or recirculation air) from a second air source is flowable into the second intake region 120b via the second inlet 124. The intake regions 120a, 120b are in selective fluid communication with the unfiltered region 120c via the airflow opening 128. The filter 190 is disposed between and separates (to at least an extent) the unfiltered region 120c and the filtered region 120d. The filtered region 120d is in fluid communication with an internal space 204 of the blower housing 202 via the air outlet 126 of the valve housing 102 and the inflow opening 206 of the blower housing 202. The first input air 20 and/or the second input air 22 may be drawn into the first and second intake region 120a, 120b, respectively, and drawn and/or driven through the valve assembly 100 and the blower assembly 200 via the blower 210. The valve 180 is adjustable about a first axis 182 via the motor 14 to selectively open and close the airflow opening 128 with respect to the intake regions 120a, 120b. Adjustment of the valve 180 also selectively opens and closes a valve opening 130 via which the intake regions 120a, 120b are in selective fluid communication. The compensation door 140 is adjustable about a second axis 142 via the actuator 160 to selectively compensate for high air pressure in the first intake region 120a (e.g., in the inlet cowl 102b of the valve housing 102) and/or to maintain an approximately net zero or slightly negative net force between a ram air pressure (e.g., in the inlet cowl 102b) and a suction pressure of the blower 210.

As generally illustrated in FIGS. 3 and 4, during operation of the HVAC module 10, air (e.g., first input air 20) flows into the first intake region 120a via the first inlet 122 and/or air (e.g., second input air 22) flows into the second intake region 120b via the second inlet 124. The first input air 20 in the first intake region 120a and/or the second input air 22 in the second intake region 120b flows through the airflow opening 128 based on the position of the valve 180. Air 20, 22 flowing through the airflow opening 128, which may be considered and/or referred to as an airflow 24, flows into the unfiltered region 120c, through the filter 190, and into the filtered region 120d. The airflow 24 then flows from the filtered region 120d into the blower assembly 200 via the air outlet 126 and the inflow opening 206, flows through the blower 210 and the internal space 204 of the blower housing 202, and is output and/or expelled from the blower assembly 200 and/or the HVAC module 10 as output air 26. The output air 26 may ultimately be directed to one or more destinations (e.g., a windshield/defrost zone of a vehicle cabin, an upper portion or region/passenger zone of a vehicle cabin, a lower portion or region/footwell zone of a vehicle cabin).

As vehicle speed increases more first input air 20 naturally flows into the inlet cowl 120b and/or the first intake region 120a resulting in increased air pressure (i.e., ram air pressure) within the inlet cowl 102b and/or the first intake region 120a. When the vehicle is traveling at high rates of speed (e.g., at or greater than 40 mph) and the blower 210 is operated at a lower speed, first input air 20 may leak into the second intake region 120b and/or out through the second inlet 124 (e.g., second inlet openings 124a) due to the elevated and/or high air pressure within the inlet cowl 102b and/or the first intake region 120a. The elevated and/or high air pressure within the inlet cowl 102b may even cause first input air 20 to leak passed the valve 180 and through the valve opening 130 when the valve 180 is intended to seal and/or close the valve opening 130 (i.e., when the valve 180 is disposed in the first or second position). This leakage may, for example, result in hot or cold first input air 20 from outside of the vehicle leaking into the vehicle cabin and causing passenger discomfort. In addition, the elevated and/or high air pressure within the inlet cowl 102b may produce and/or result in a positive net force and/or pressure differential between the air pressure within the inlet cowl 102b and the suction pressure of the blower 210. This positive net force and/or pressure differential works against the blower 210 and has to be overcome by the blower 210 during operation, which negatively impacts and/or reduces efficiency of the blower 210. These challenges, however, are solved, addressed, and/or mitigated via operation of the compensation door 140.

During operation of the HVAC module 10, the actuator 160 adjusts the compensation door 140 to an active position when the air pressure within the inlet cowl 102b and downstream of the compensation door 140 (i.e., the air pressure in the downstream region 120f) exceeds a predetermined air pressure threshold (e.g., approximately 50-100 Pa). As a result, the compensation door 140 partially blocks, restricts, and/or limits the flow of first input air 20 within the inlet cowl 102b (e.g., the flow of first input air 20 from the upstream region 120e to the downstream region 120f). This in turn establishes and/or maintains the air pressure in the downstream region 120f at or below a predetermined air pressure valve (e.g., 25 Pa) while an elevated air pressure at or exceeding the predetermined air pressure threshold and/or the predetermined air pressure valve (e.g., an elevated air pressure of 25-250 Pa) is present in the upstream region 120c. It also maintains an approximately net zero or slightly negative net force and/or pressure differential between the air pressure in the downstream region 120f and the suction pressure of the blower 210. Consequently, the unintended and undesirable leakage of first input air 20 into the second intake region 120b and/or out through the second inlet 124 (e.g., second inlet openings 124a) is restricted, limited, and/or eliminated and the efficiency of the blower 210 is maintained and/or improved.

As generally illustrated in FIGS. 1-4, the valve housing 102 defines an internal space 120 in which the valve 180, the compensation door 140, and the filter 190 are arranged. The valve housing 102 includes a filter section 102a, a first inlet section 102b (e.g., an inlet cowl), and a second inlet section 102c. The valve housing 102 also includes at least one end wall 106, one or more sidewalls 108a-108d, and a plurality of partitions (e.g., a first partition 104a, a second partition 104b). The first partition 104a extends transversely to the sidewalls 108a-108d and projects from and/or is connected to the sidewalls 108a-108d. The sidewalls 108a-108d extend between and connect the end wall 106 and the first partition 104a, which region and/or portion of the valve housing 102 may be considered the filter section 102a of the valve housing 102. The second partition 104b extends between the first and second sidewalls 108a, 108b and is oriented transversely (e.g., obliquely and/or perpendicularly) to the first partition 104a and the first and second sidewalls 108a, 108b. The first inlet section 102b and the second inlet section 102c are disposed on and/or extend from the first partition 104a and/or the filter section 102a, and are connected to and/or separated from one another by the second partition 104b. The first inlet section 102b is configured as, and may be referred to as, an inlet cowl 102b. The inlet cowl 102b includes and/or defines the first inlet 122 and/or the first inlet opening 122a. The inlet cowl 102b is at least partially defined by the first sidewall 108a, the second sidewall 108b, a first cowl wall 110a, and a second cowl wall 110b of the valve housing 102. The first cowl wall 110a projects from the first partition 104a, and extends between and connects the first and second sidewalls 108a, 108b. The second cowl wall 110b projects from the second partition 104b, and extends between and connects the first and second sidewalls 108a, 108b. The second inlet section 102c is at least partially defined by the first sidewall 108a, the second sidewall 108b, and a wall 112. The wall 112 is a curved and/or arc-shaped wall that extends between and connects the first sidewall 108a, the second sidewall 108b, the first partition 104a, and the second partition 104b. Conceivably, the wall 112 may planar and/or the second inlet section 102c may be configured as a second inlet cowl 102b (e.g., substantially similar to the first inlet section 102b).

As generally illustrated in FIGS. 1-4, the valve housing 102 includes a plurality of air inlets 122, 124 via which air is flowable into the internal space 120. The plurality of air inlets 122, 124 includes a first inlet 122 (e.g., a fresh air inlet) via which first input air 20 (e.g., external air) from the first air source is flowable into the first intake region 120a. The first inlet 122 includes and/or is defined by a first inlet opening 122a, which is disposed in and defined by the inlet cowl 102b (e.g., the sidewalls 108a, 108b and cowl walls 110a, 110b) of the valve housing 102.

The plurality of air inlets 122, 124 further includes a second inlet 124 (e.g., a recirculation air inlet) via which second input air 22 (e.g., recirculation air) from the second air source is flowable into the second intake region 120b. The second inlet 124 includes and/or is defined by a plurality of second inlet openings 124a, which are disposed in and/or defined by the second inlet section 102c (e.g., a region of the side walls 108a, 108b and the wall 112) of the valve housing 102. The valve housing 102 includes several subsets or groups of second inlet openings 124a. Each subset or group of second inlet openings 124a includes a plurality of second inlet openings 124a that are arranged in a closely packed array (e.g., a grid arrangement, a honeycomb arrangement) and defined by a region and/or section of the valve housing 102 that is structured in the manner of a mesh and/or lattice. Conceivably, the second inlet 124 may alternatively include and/or formed by a single second inlet opening 124a, a single subset or group of second inlet openings 124a, or in other suitable configurations (e.g., as an opening of a second inlet cowl 102b).

As generally illustrated in FIGS. 1-4, the valve housing 102 includes an air outlet 126 via which air (i.e., input air 20, 22 that has passed through the filter 190; the airflow 24) is expelled and/or flowable out of the valve housing 102. The air outlet 126 includes and/or is defined by an outlet opening 126a, which is disposed in and/or defined by the valve housing 102 (e.g., the end wall 106). The filtered region 120d of the internal space 120 of the valve housing 102 and the internal space 204 of the blower assembly 200 are in direct fluid communication with one another via the air outlet 126 and the inflow opening 206 of the blower assembly 200.

As generally illustrated in FIGS. 3 and 4, the valve housing 102 includes at least one airflow opening 128. The airflow opening 128 is disposed in and defined by the first partition 104a. The airflow opening 128 fluidically connects each of the intake regions 120a, 120b to the unfiltered region 120c. The airflow opening 128 is selectively openable and closeable with respect to the intake regions 120a, 120b via the valve 180.

As generally illustrated in FIGS. 3 and 4, the valve housing 102 includes at least one valve opening 130 that adjustably receives and/or retains the valve 180. The valve opening 130 is disposed in and defined by the second partition 104b. The valve opening 130 fluidically connects the intake regions 120a, 120b to one another. The valve 180 is disposed at least partially in the valve opening 130 and is adjustable and/or rotatable within the valve opening 130. The valve opening 130 is selectively openable and closeable via the valve 180.

As generally illustrated in FIGS. 3 and 4, the internal space 120 includes a first intake region 120a, a second intake region 120b, an unfiltered region 120c, and a filtered region 120d.

As generally illustrated in FIGS. 3 and 4, the first intake region 120a is disposed in the inlet cowl 102b and the second intake region 120b is disposed in the second inlet section 102c. The first intake region 120a is defined at least partially by the inlet cowl 102b, the first partition 104a, and the second partition 104b. The second intake region 120b is defined at least partially by the second inlet section 102c, the first partition 104a, and the second partition 104b. In other words, the first intake region 120a and the second intake region 120b are disposed on opposite sides of the valve 180, the second partition 104b, and the valve opening 130.

The intake regions 120a, 120b are in selective fluid communication with one another via the valve opening 130 and may be selectively closed off and/or sealed from one another via the valve 180. For example, the intake regions 120a, 120b are in fluid communication when one another via the valve opening 130 when the valve 180 is disposed in an intermediate position. The intake regions 120a, 120b are fluidically sealed off from one another (i.e., the valve opening 130 is closed) via the valve 180 when the valve 180 is disposed in the first position and when disposed in the second position. The first intake region 120a and the second intake region 120b are in selective fluid communication with the unfiltered region 120c via the airflow opening 128 and may be selectively closed off and/or sealed from the unfiltered region 120c via the valve 180.

The first intake region 120a includes an upstream region 120e and a downstream region 120f. The upstream region 120e is disposed downstream of the first inlet 122 and/or the inlet opening 122a and upstream of the compensation door 140. The downstream region 120f is disposed downstream of the compensation door 140 and upstream of the partitions 104a, 104b, and/or the valve 180. In other words, the upstream region 120e and the downstream region 120f are disposed on opposite sides of the compensation door 140 relative to the flow direction of first input air 20 through the valve housing 102 and/or inlet cowl 102b. The upstream region 120e and the downstream region 120f are in fluid communication with one another. Fluid communication and/or the flow of first input air 20 between the upstream region 120e and the downstream region 120f may be partially blocked, restricted, and/or limited via adjusting a position of the compensation door 140. While the compensation door 140 does not seal and/or completely prevent fluid communication between the upstream region 120e and the downstream region 120f, such a configuration is contemplated.

As generally illustrated in FIGS. 3 and 4, the unfiltered region 120c is disposed in the filter section 102a. The unfiltered region 120c is at least partially defined by the filter 190 and the valve housing 102 (e.g., the first partition 104a, the sidewalls 108a-108d). The unfiltered region 120c is in fluid communication with the filtered region 120d via the filter 190. The unfiltered region 120c is in selective fluid communication with the intake regions 120a, 120b via the airflow opening 128, and may be selectively closed off and/or sealed from one or more of the intake regions 120a, 120b via the valve 180.

As generally illustrated in FIGS. 3 and 4, the filtered region 120d is disposed in the filter section 102a. The filtered region 120 is defined at least partially by the filter 190 and the valve housing 102 (e.g., the end wall 106, the sidewalls 108a-108d). The filtered region 120d is in fluid communication with the unfiltered region 120c via the filter 190. The filtered region 120d is in fluid communication with the blower assembly 200 via the air outlet 126 and the inflow opening 206.

As generally illustrated in FIGS. 1, 3, and 4, the valve assembly 100 includes at least one adjustable compensation door 140 (e.g., a ram air compensation door 140). The compensation door 140 is connected to the actuator 160 and, by way of the actuator 160, is adjustable (e.g., pivotable) by, based on, and/or according to the air pressure within the inlet cowl 102b (e.g., the downstream region 120f). The compensation door 140 includes a door body 144 and a second shaft 146. The door body 144 is curved and/or arc shaped and includes a plurality of integral reinforcement and/or flow guiding ribs 148. Alternatively, the door body 144 may be planar or another suitable shape and/or configuration, the door body 144 and the ribs 148 may not be integrally formed as a monolithic component, and/or the door body 144 may not include reinforcement and/or flow guiding ribs 148. The second shaft 146 extends longitudinally along and/or defines the second axis 142. The second shaft 146 is connected to and/or projects from opposite ends of the door body 144. The door body 144 and the second shaft 146 are integrally formed as a single, monolithic piece in the depicted illustrative example, but may alternatively be structured as separate individual components that are connected to one another. The second shaft 146 is rotatably mounted in and/or extends through (i) a first door-shaft recess 116a disposed in and defined by the first sidewall 108a of the valve housing 102 and (ii) a second door-shaft recess 116b disposed in and defined by the second sidewall 108b of the valve housing 102. In this way, the compensation door 140 and the second shaft 146 are rotatably supported by the valve housing 102. One end of the second shaft 146 is connected to the actuator 160 (see FIGS. 1, 5, and 6). In other words, the compensation door 140 and the actuator 160 are connected to one another via the second shaft 146.

The compensation door 140 is arranged in the inlet cowl 102b of the valve housing 102 (i.e., in the first intake region 120a) at least partially between the upstream region 120e and the downstream region 120f. The compensation door 140 is also arranged between the first inlet 122 (e.g., the first inlet opening 122a) and the valve 180, the first partition 104a, and/or the airflow opening 128. Relative to a through flow direction of first input air 20 (e.g., when the valve 180 is in the first position), the compensation door 140 is disposed downstream of the first inlet opening 122a and the upstream region 120c, and is disposed upstream of the downstream region 120f, the actuator opening 118, the fluid passage 168, the valve 180, and the airflow opening 128.

The compensation door 140 is adjustable (e.g., rotatable and/or pivotable) about the second axis 142 to an active position, an inactive position, and one or more partially-active positions. The compensation door 140 is adjusted (e.g., rotated and/or pivoted) about the second axis 142 (e.g., via the actuator 160) to selectively control, influence, restrict, and/or limit the flow of first input air 20 into, within, and/or through the valve housing 102 and/or the inlet cowl 102b (e.g., from the upstream region 120e to the downstream region 120f) to compensate for high air pressure (e.g., air pressure above the predetermined air pressure threshold) within the inlet cowl 102b (e.g., the downstream region 120f). The compensation door 140 is passively, automatically, and dynamically adjusted about the second axis 142 via the actuator 160 by, based on, and/or according to the air pressure within the inlet cowl 102b (e.g., the downstream region 120f) to (i) establish and/or maintain the air pressure within the downstream region 120f at or below a predetermined air pressure value (e.g., 25 Pa) and/or (ii) maintain an approximately net zero or slightly negative pressure differential between the air pressure within the downstream region 120f and a suction pressure of the blower 210. In this manner, the compensation door 140 is able to (i) restrict, limit, and/or eliminate unintended and undesirable leakage of first input air 20 into the second intake region 120b and/or out through the second inlet 124 and (ii) maintain and/or improve efficiency of the blower 210, such as when the vehicle is traveling at high speeds.

The compensation door 140 is disposed in the inactive position, which is depicted in FIGS. 1 and 3, when the air pressure within the downstream region 120f is below the predetermined air pressure threshold. Additionally, the compensation door 140 may be disposed in and/or adjusted to the inactive position when the valve 180 is disposed in the first position, the second position, or one or more intermediate positions. When in the inactive position, the compensation door 140 and/or the door body 144 (e.g., a blocking surface thereof) is arranged and/or oriented in the flow direction of first input air 20 through the inlet cowl 102b and/or in a complimentary manner to the second cowl wall 110b such that the compensation door 140 and/or the door body 144 does not significantly and/or materially block, restrict, and/or limit (e.g., as little as possible, and/or to a lesser extent than when in the active position and when in at least one of the partially-active positions) the flow of first input air 20 into and/or through the inlet cowl 102b (e.g., from the upstream region 120e to the downstream region 120f).

The compensation door 140 is disposed in the active position, which is depicted in FIG. 4, when the air pressure within the downstream region 120f exceeds the predetermined air pressure threshold. Additionally, the compensation door 140 may be disposed in and/or adjusted to the active position when the valve 180 is disposed in the first position, the second position, or one or more intermediate positions. When in the active position, the compensation door 140 and/or the door body 144 (e.g., the blocking surface thereof) is arranged and/or oriented transversely (e.g., substantially perpendicularly) to the through flow direction of first input air 20 and/or to the second cowl wall 110b such that the compensation door 140 and/or the door body 144 partially blocks, restricts, and/or limits the flow of first input air 20 into and/or through the inlet cowl 102b (e.g., from the upstream region 120e to the downstream region 120f) at least to a greater extent than when disposed in the inactive position. The compensation door 140 and/or the door body 144 is disposed spaced apart from and/or does not (e.g., sealingly) contact, rest on, or touch the internal surfaces of the inlet cowl 102b when in the active position. As such, the compensation door 140 only partially blocks, restricts, and/or limits the flow of first input air 20 and does not form a fluid tight seal between the upstream region 120e and the downstream region 120f, nor completely prevent first input air 20 from flowing through the inlet cowl 102b (e.g., from the upstream region 120e to the downstream region 120f). Nevertheless, such a configuration is contemplated.

When in one or more of the partially-active positions, the compensation door 140 and/or the door body 144 (e.g., the blocking surface thereof) is arranged and/or oriented transversely (e.g., obliquely) to the through flow direction of first input air 20 and/or to the second cowl wall 110b such that the compensation door 140 and/or the door body 144 partially blocks, restricts, and/or limits the flow of first input air 20 into and/or through the inlet cowl 102b (e.g., from the upstream region 120c to the downstream region 120f) to a lesser extent than when in the inactive position, but to a greater extent than when in the active position.

As generally illustrated in FIGS. 1, 5, and 6, the actuator 160 is disposed outside of the internal space 120 and/or the valve housing 102. The actuator 160 is connected to and/or mounted on the inlet cowl 102b on the first sidewall 108a of the valve housing 102. The actuator 160 is also connected to the second shaft 146 via a lever 158. The actuator 160 includes an adjustable plunger 162, at least one tube 166 (e.g., at least one static pressure communication tube 166), and a biasing member 170 (e.g., a return spring). The actuator 160 is configured to adjust (e.g., rotate and/or pivot) the compensation door 140 about the second axis 142, such as to the active position, the inactive position, and/or one or more partially-active positions. The actuator 160 is further configured to adjust the compensation door 140 to the active position (e.g., from the inactive position) when the air pressure within the downstream region 120f exceeds a predetermined air pressure threshold (e.g., approximately 50-100 Pa).

In contrast to the motor 14, the actuator 160 is not actively controlled, activated, and/or powered by the controller 12 or another electrical system (e.g., of the HVAC module 10 or vehicle). Rather, the actuator 160 is in fluid communication with the internal space 120 (e.g., the first intake region 120a, more specifically the downstream region 120f) and/or the valve housing 102 (e.g., the inlet cowl 102b) and is passively controlled by the first input air 20 and/or the air pressure in the inlet cowl 102b (e.g., the downstream region 120f). The actuator 160 may therefore be considered and/or referred to as a pneumatic and/or passive actuator. As explained in detail below, the plunger 162 of the actuator 160 is adjustable to an extended position, a retracted position, and one or more partially-extended positions by the first input air 20 based on the air pressure within the inlet cowl 102b (e.g., in the downstream region 120f). Movement and/or adjustment of the plunger 162 adjusts the lever 158, which adjusts the position of the compensation door 140. The actuator 160 therefore passively, automatically, and/or dynamically adjusts the compensation door 140 based on, according to, and/or utilizing the air pressure within the inlet cowl 102b (e.g., the downstream region 120f).

As generally illustrated in FIGS. 1, 5, and 6, the lever 158 is disposed outside of the internal space 120 and/or the valve housing 102. A first longitudinal end of the lever 158 is non-rotatably connected and/or fixed to the end of the second shaft 146 thereby connecting the compensation door 140 and the actuator 160. A second, opposite longitudinal end of the lever 158 is rotatably and/or pivotably connected to the plunger 162. The lever 158 is adjustable (e.g., rotatable and/or pivotable) about the second axis 142, such as via movement and/or adjustment of the plunger 162. Adjusting (e.g., rotating and/or pivoting) the lever 158 about the second axis 142 adjusts (e.g., rotates and/or pivots) the second shaft 146, and consequently the door body 144 connected thereto, about the second axis 142 thereby adjusting the position of the compensation door 140. Optionally, a longitudinal dimension and/or length of the lever 158 in a direction extending from the first end to the second end is 2.5 to 8 cm.

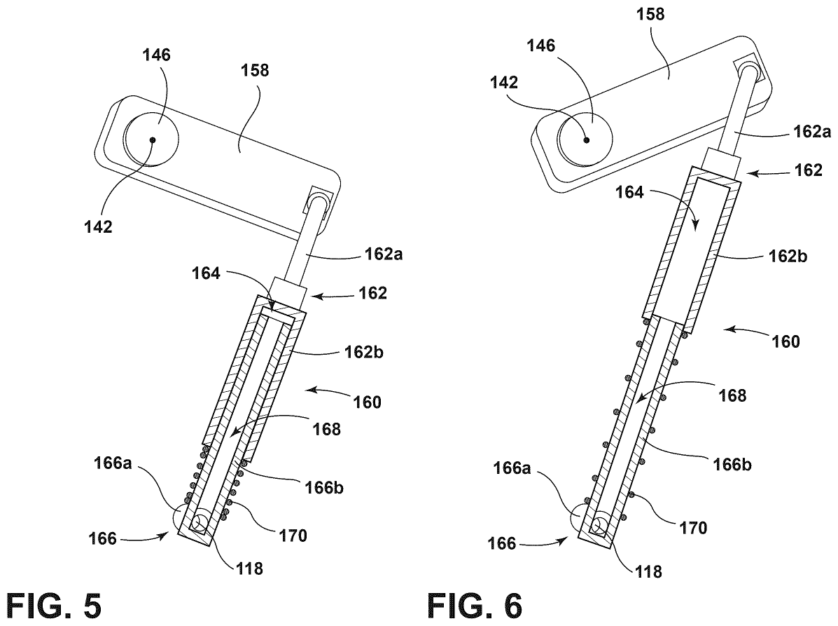

As generally illustrated in FIGS. 5 and 6, the tube 166 is a hollow, annular body defining a fluid passage 168. The tube 166 includes and/or is defined by a first tube portion 166a and a second tube portion 166b that extend transversely (e.g., obliquely and/or perpendicularly) relative to one another. The first and second tube portions 166a, 166b may be configured and/or structured as a single monolithic body (e.g., with a curve, bend, and/or corner) or, alternatively, as separate tubular bodies that are connected to one another. A first longitudinal end of tube 166 and/or the first tube portion 166a is connected to the inlet cowl 102b (e.g., the first sidewall 108a) at or about an actuator opening 118, which is disposed in and defined by the inlet cowl 102b (e.g., the first sidewall 108a), such that first intake air 20 is flowable into the fluid passage 168 from the downstream region 120f via the actuator opening 118. An opposite, second longitudinal end of the tube 166 and/or the second tube portion 166b is adjustably (e.g., slidably) disposed in the chamber 164 of the plunger 162.

As generally illustrated in FIGS. 1, 5, and 6, a first axial end of the plunger 162 is connected to the lever 158. A second, opposite axial end of the plunger 162 includes and/or defines a chamber 164 in which the tube 166 (e.g., the second tube portion 166b) is at least partially disposed. In some examples, (i) a first portion and/or a first axial end of the plunger 162 is structured as a connecting rod 162a and (ii) a second portion and/or a second axial end of the plunger 162 is an annular and/or hollow cylinder body 162b. The plunger 162 is adjustably (e.g., slidably) arranged on the tube 166 (e.g., the second tube portion 166b) such that the plunger 162 is adjustable (e.g., slidable) relative to the tube 166 and/or the valve housing 102 to a retracted position, an extended position, and/or one or more partially-extended positions between the retracted position and the extended position. The compensation door 140 is disposed in the inactive position (see, e.g., FIG. 3) when the plunger 162 is in the retracted position (see, e.g., FIG. 5). The compensation door 140 is disposed in the active position (see, e.g., FIG. 4) when the plunger 162 is in the extended position (see, e.g., FIG. 6). The chamber 164 of the plunger 162 is in fluid communication with the first intake region 120a (e.g., the downstream region 120f) via the fluid passage 168 of the tube 166 and the actuator opening 118, which enables the first input air 20 and/or the air pressure in the inlet cowl 102b (e.g., the downstream region 120f) to adjust the plunger 162, and consequently, the compensation door 140. Optionally, the chamber 164 has a diameter of 1 to 75 mm (e.g., 1 mm, 3 mm, 25 mm, 50 mm, or 75 mm) and a longitudinal dimension and/or length of the plunger 162 in an axial direction extending from the first end to the second end is 25 to 50 mm.

As generally illustrated in FIGS. 1, 5, and 6, the biasing member 170 is arranged on, connected to, and/or in contact with the plunger 162. The biasing member 170 biases the plunger 162 to and/or toward the retracted position and, thus, biases the compensation door 140 toward the inactive position. The biasing member 170 also resists adjustment of the plunger 162 toward the extended position (e.g., adjustment of the compensation door 140 toward the active position). In the illustrative example herein, the biasing member 170 is a helical return spring that is wound around the first tube portion 166a of the tube 166. A first end of the return spring 170 is connected to the plunger 162 (e.g., the second end thereof). A second, opposite end of the return spring 170 is connected to the tube 166. The return spring 170 is pulled and elastically deformed (e.g., stretched out) as the plunger 162 moves toward the extended position. When the plunger 162 is in the extended position, the return spring 170 is under tension and exerts a return force on the plunger 162 that biases, draws, and/or pulls the plunger 162 back toward the retracted position and/or toward the second tube portion 166b. Alternatively, the return spring 170 may be structured and arranged to compress as the plunger 162 moves toward the extended position, and push/press the plunger 162 back toward the retracted position and/or toward the second tube portion 166b. Conceivably, the biasing member 170 may be configured in other suitable manners (e.g., as a leaf spring) to bias the plunger 162 toward the retracted position.

The plunger 162 is depicted in the retracted position in FIGS. 1 and 5. When the plunger 162 is in the retracted position, the second end of the tube 166 is disposed proximal to and/or near a closed end of the chamber 164 and/or is disposed closer to the closed end of the chamber 164 than when the plunger 162 is in the extended position. Additionally, the plunger 162 and the second end of the lever 158 are disposed closer to the first tube portion 166a and/or the actuator opening 118 than when the plunger 162 is in the extended position. The return spring 170 is at or near equilibrium (i.e., is not under tension) or is under less tension than when the plunger 162 is in the extended position, and maintains the plunger 162 in the retracted position and the compensation door 140 is disposed in the inactive position when the air pressure within the downstream region 120f is below the predetermined air pressure threshold.

The plunger 162 is depicted in the extended position in FIG. 6. When the plunger 162 is in the extended position, the second end of the tube 166 is disposed proximal to, adjacent to, and/or near an open end of the chamber 164 and/or is disposed closer to the open end of the chamber 164 than when the plunger 162 is in the retracted position. The plunger 162 and the second end of the lever 158 are disposed farther from the first tube portion 166a and/or the actuator opening 118 than when the plunger 162 is in the retracted position. The return spring 170 is under a greater amount of tension than when the plunger 162 is in the retracted position and exerts a return force on the plunger 162 that biases the plunger 162 toward the retracted position and/or the second tube portion 166b. The plunger 162 is disposed in the extended position and the compensation door 140 is disposed in the active position when the air pressure within the downstream region 120f exceeds the predetermined air pressure threshold.

During operation of the HVAC module 10 and/or the vehicle, when air pressure of the first input air 20 within the inlet cowl 102b (e.g., the downstream region 120f) exceeds the predetermined air pressure threshold, the first input air 20 in the downstream region 120f flows through the actuator opening 118 and the fluid passage 168 into the chamber 164. This in turn increases the air pressure in the chamber 164 and the first input air 20 in the chamber 164 applies sufficient force to the plunger 162 to overcome the force of the return spring 170. As a result, the plunger 162 slides along and/or on the second tube portion 166b in a direction away from the first tube portion 166a and/or the actuator opening 118 (e.g., toward the extended position). The movement of the plunger 162 pulls and/or elastically deforms (e.g., stretches out) the return spring 170 putting the return spring 170 under tension. The movement of the plunger 162 also pushes, adjusts, and/or moves the second end of the lever 158 away from the first tube portion 166a and/or the actuator opening 118, which adjusts (e.g., rotates and/or pivots) the lever 158 about the second axis 142. The adjustment of the lever 158 adjusts (e.g., rotates and/or pivots) the compensation door 140 about the second axis 142 toward the active position. More specifically, the lever 158 adjusts (e.g., rotates and/or pivots) the second shaft 146 about the second axis 142, which in turn adjusts (e.g., rotates and/or pivots) the door body 144 about the second axis 142. Adjusting the compensation door 140 toward and/or to the active position causes the compensation door 140 and/or the door body 144 to partially block, restrict, and/or limit (e.g., nearly completely and/or to a greater extent than when in the inactive position) the flow of first input air 20 from the upstream region 120e to the downstream region 120f. This in turn (i) establishes and/or maintains the air pressure in the downstream region 120f at or below the predetermined air pressure value and/or (ii) maintains an approximately net zero or slightly negative pressure differential between the air pressure in the downstream region 120f and the suction pressure of the blower 210. As a result, the efficiency of the blower 210 is maintained and/or improved, and the unintended and undesirable leakage of first input air 20 into the second intake region 120b and/or out through the second inlet 124 (e.g., second inlet openings 124a) is mitigated, reduced, and/or prevented thereby increasing passenger comfort and/or improving efficiency of one or more air heating/cooling systems of the vehicle.

When the air pressure of the first input air 20 within the inlet cowl 102b (e.g., the downstream region 120f) falls below the predetermined air pressure threshold, the decreased air pressure within the downstream region 120f causes the first input air 20 within the chamber 164 of the actuator 160 to flow through the fluid passage 168 and the actuator opening 118 into the downstream region 120f. This in turn decreases the air pressure in the chamber 164 and the force applied to the plunger 162 by the first input air 20 is reduced to a level/value below the return force of the return spring 170. The return spring 170 adjusts, moves, and/or slides the plunger 162 along the second tube portion 166b toward the first tube portion 166a (e.g., toward the retracted position). The movement of the plunger 162 pulls, adjusts, and/or moves the second end of the lever 158 toward the first tube portion 166a and/or the actuator opening 118, which adjusts (e.g., rotates and/or pivots) the lever 158 about the second axis 142. The adjustment of the lever 158 adjusts (e.g., rotates and/or pivots) the compensation door 140 about the second axis 142 toward the inactive position. More specifically, the lever 158 adjusts (e.g., rotates and/or pivots) the second shaft 146 about the second axis 142, which in turn adjusts (e.g., rotates and/or pivots) the door body 144 about the second axis 142. Adjusting the compensation door 140 toward and/or to the inactive position causes the compensation door 140 and/or the door body 144 to no longer block, restrict, and/or limit (or to block, restrict, and/or limit to a lesser extent) the flow of first input air 20 from the upstream region 120e to the downstream region 120f.

In some examples, rather than the passive and/or pneumatic actuator 160 described above, the compensation door 140 is connected to and adjusted by a motorized actuator that is connected to and controlled by the controller 12. In such examples, one or more air pressure sensors (e.g., a pressure transducer) detect the air pressure within the downstream region 120f and communicate the detected air pressure to the controller 12. The controller 12 actively and dynamically adjusts the position of the compensation door 140 via activating the actuator to maintain the air pressure within the downstream region 120f at or below the predetermined air pressure value (e.g., 25 Pa). For example, the controller 12 adjusts the compensation door 140 based on a gain, integral, and/or derivative of the angle of the compensation door 140 and the response in the detected air pressure within the downstream region 120f as the compensation door 140 is adjusted. Additionally and/or alternatively, the controller 12 actively and dynamically adjusts the position of the compensation door 140 based on a determined net force and/or pressure differential between the detected air pressure within the downstream region 120f and the suction pressure of the blower 210. For example, the controller 12 adjusts the compensation door 140 toward the active position when the determined net force and/or pressure differential is positive and/or greater than 0 Pa.

As generally illustrated in FIGS. 3 and 4, the valve assembly 100 includes at least one adjustable valve 180. The valve 180 is arranged in the valve housing 102 (e.g., in the internal space 120) at least partially between the first and second intake regions 120a, 120b and controls the flow of air through the HVAC module 10. The valve 180 includes at least one seal 186, 188. The first seal 186 is connected to and projects outward from the valve 180 and extends at least partially around a first open end of the valve 180. The second seal 188 is connected to and projects outward from valve 180 and extends at least partially around a second open end of the valve 180. The first seal 186 and second seal 188 are separate and independent elements, but may conceivably be connected to one another and/or formed as a singular seal, and/or may be formed integrally with the valve 180. While only a single valve 180 is depicted in the figures, the HVAC module 10 may include a plurality of valves 180 (e.g., arranged in a row) that each selectively open and/or close a respective airflow opening 128.

The valve 180 is disposed at least partially within the inlet cowl 102b, the second inlet section 102c, and the valve opening 130 of the second partition 104b. The valve 180 is adjustable and/or rotatable about the first axis 182 (e.g., via the motor 14) to selectively open and close the airflow opening 128 and the valve opening 130 with respect to the intake regions 120a, 120b. The valve 180 includes and/or is connected to a first shaft 184, which extends along and/or defines the first axis 182. The first shaft 184 is disposed in and/or extends through (i) a first shaft recess 114a disposed in and defined by the first sidewall 108a of the valve housing 102 and (ii) a second shaft recess 114b disposed in and defined by the second sidewall 108b of the valve housing 102. An end of the first shaft 184 is connected to the motor 14 (see FIG. 1). In other words, the first shaft 184 connects the valve 180 and the motor 14 to one another. The motor 14 is disposed on a first side of the valve housing 102 and is arranged outside of the valve housing 102 adjacent to the first sidewall 108a of the valve housing 102. The motor 14 is configured to adjust the valve 180 about the first axis 182. The motor 14 is connected to the controller 12. The controller 12 is configured to control, operate, and/or actuate the motor 14 to rotate the first shaft 184, which in turn adjusts and/or rotates the valve 180 about the first axis 182.

The valve 180 is adjustable and/or rotatable about the first axis 182 (e.g., via the motor 14) to a variety of positions, including a first position (see FIG. 3), a second position (see FIG. 4), and a plurality of intermediate positions between the first and second positions. When in the first position (see FIG. 3), the first seal 186 contacts, abuts, and/or presses against the second partition 104b and the second seal 188 contacts, abuts, and/or presses against the first partition 104a. Thus, when in the first position, the valve 180 closes the airflow opening 128 with respect to the second intake region 120b and does not close the airflow opening 128 with respect to the first intake region 120a such that the first input air 20 is permitted to flow through the airflow opening 128 and the second input air 22 is restricted and/or prevented from flowing through the airflow opening 128. When in the second position (see FIG. 4), the first seal 186 contacts, abuts, and/or presses against the first partition 104a and the second seal 188 contacts, abuts, and/or presses against the second partition 104b. Thus, when in the second position, the valve 180 closes the airflow opening 128 with respect to the first intake region 120a and does not close the airflow opening 128 with respect to the second intake region 120b such that the second input air 22 is permitted to flow through the airflow opening 128 and the first input air 20 is restricted and/or prevented from flowing through the airflow opening 128. When the valve 180 is in the first position (see FIG. 3) and when the valve 180 is in the second position (see FIG. 4), the valve 180 closes the valve opening 130 of the second partition 104b (e.g., via the first seal 186 and the second seal 188 contacting the second partition 104b, respectively) such that first input air 20 is restricted and/or prevented from flowing through the valve opening 130 into the second intake region 120b and second input air 20 is restricted and/or prevented from flowing through the valve opening 130 into the first intake region 120a. When in one or more intermediate positions, the seals 186, 188 do not contact the first partition 104a nor the second partition 104b. Thus, when in one or more intermediate positions, the valve 180 does not close the airflow opening 128 with respect to the first intake region 120a nor the second intake region 120b such that both the first and second input air 20, 22 are permitted to flow through the airflow opening 128 and through the valve opening 130.

As generally illustrated in FIGS. 3 and 4, the filter 190 is configured to remove and/or collect impurities from air (e.g., the input air 20, 33 and/or the airflow 24) flowing through the filter 190. The filter 190 is arranged in the filter section 102a of the valve housing 102 (e.g., within the internal space 120). The filter 190 is releasably engaged by and/or connected to the valve housing 102 (e.g., one or more sidewalls 108a-108d thereof) enabling the filter 190 to be easily removed and replaced, such as by removing an access panel and/or cover that closes an opening in valve housing 102. The filter 190 is disposed between and/or separates (to at least an extent) the unfiltered region 120c and the filtered region 120d such that the airflow 24 is flowable (e.g., exclusively) from the unfiltered region 120c into the filtered region 120d via flowing through the filter 190.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both element, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. A valve assembly for a heating, ventilation, and air conditioning (HVAC) module, comprising:
a valve housing including an inlet cowl;
an adjustable valve disposed in the valve housing;
an adjustable compensation door disposed in the inlet cowl upstream of the valve; and
an actuator connected to the compensation door;
wherein the actuator is in fluid communication with the inlet cowl and adjusts the compensation door based on an air pressure in the inlet cowl.

2. The valve assembly of claim 1, wherein:
the valve housing defines an internal space;
the actuator is in fluid communication with a downstream region of the internal space that is disposed downstream of the compensation door and upstream of the valve.

3. The valve assembly of claim 1, wherein:
the compensation door is pivotable to an active position and an inactive position; and
when disposed in the active position, the compensation door restricts airflow through the inlet cowl to a greater extent than when disposed in the inactive position.

4. The valve assembly of claim 3, wherein:
the compensation door is oriented transversely to a flow direction of air through the inlet cowl when disposed in the active position; and
the compensation door is oriented in the flow direction of air through the inlet cowl when disposed in the inactive position.

5. The valve assembly of claim 3, wherein, the compensation door only partially blocks airflow through the inlet cowl when disposed in the active position.

6. The valve assembly of claim 3, wherein:
the compensation door is disposed in the inactive position when the air pressure in the inlet cowl is below a predetermined air pressure threshold; and
the compensation door is disposed in the active position when the air pressure in the inlet cowl exceeds the predetermined air pressure threshold.

7. The valve assembly of claim 1, wherein:
the actuator includes an adjustable plunger; and
the actuator is in fluid communication with the inlet cowl such that the plunger is adjustable to (i) an extended position via air flowing into the actuator from the inlet cowl and (ii) a retracted position via air flowing into the inlet cowl from the actuator.

8. The valve assembly of claim 7, wherein the compensation door is connected to the plunger such that:
when the plunger is disposed in the extended position, the compensation door is disposed in an active position and restricts airflow through the inlet cowl; and
when the plunger is disposed in the retracted position, the compensation door is disposed in an inactive position and restricts airflow through the inlet cowl to a lesser extent than when disposed in the active position.

9. The valve assembly of claim 1, wherein:
the inlet cowl includes an actuator opening;
the actuator includes a tube defining a fluid passage; and
the tube is disposed at the actuator opening such that air within the inlet cowl is flowable into the fluid passage via the actuator opening.

10. The valve assembly of claim 9, wherein:
the actuator further includes a cavity and a plunger adjustably arranged on the tube; and
the cavity is in fluid communication with the inlet cowl via the fluid passage such that the plunger is adjustable to an extended position and to a retracted position via the air within the inlet cowl.

11. The valve assembly of claim 10, wherein:
the actuator further includes a biasing member connected to the tube and to the plunger; and
the biasing member biases the plunger toward the retracted position.

12. The valve assembly of claim 1, further comprising a lever connecting the compensation door and the actuator.

13. The valve assembly of claim 12, wherein:
a first end of the lever is coupled to the compensation door; and
a second end of the lever is rotatably connected to the actuator.

14. The valve assembly of claim 12, wherein the lever and the actuator are disposed outside of the valve housing.

15. A valve assembly for a heating, ventilation, and air conditioning (HVAC) module, comprising:
a valve housing defining an internal space, the valve housing including:
a first inlet via which a first input air is flowable into a first intake region of the internal space;
a second inlet via which a second input air is flowable into a second intake region of the internal space; and
an airflow opening;
an adjustable valve disposed in the valve housing between the first intake region and the second intake region, the valve adjustable about a first axis to selectively open and close the airflow opening with respect to the first intake region and the second intake region;
an adjustable compensation door disposed in the first intake region of the valve housing; and
an actuator connected to the compensation door and configured to adjust the compensation door about a second axis based on an air pressure in the first intake region.

16. The valve assembly of claim 15, wherein:
the first intake region includes (i) a downstream region disposed downstream of the compensation door and upstream of the valve and (ii) an upstream region disposed downstream of the first inlet and upstream of the compensation door; and
the actuator is in fluid communication with the downstream region.

17. The valve assembly of claim 15, wherein:
the actuator includes a chamber and an adjustable plunger; and
the actuator is in fluid communication with the first intake region such that the plunger is adjustable to (i) an extended position via first input air flowing into the chamber from the first intake region and (ii) a retracted position via first input air flowing into the first intake region from the chamber.

18. The valve assembly of claim 17, wherein:
the compensation door includes a door body and a shaft projecting from the door body; and
the shaft of the compensation door is connected to the plunger such that:
when the plunger is disposed in the extended position, the compensation door is disposed in an active position in which the door body is oriented transversely to a flow direction of the first input air through the first intake region; and
when the plunger is disposed in the retracted position, the compensation door is disposed in an inactive position in which the door body is oriented in the flow direction of the first input air through the first intake region.

19. The valve assembly of claim 18, further comprising a lever connecting the compensation door and the actuator, wherein:
a first end of the lever is non-rotatably coupled to the shaft of the compensation door; and
a second end of the lever is rotatably connected to the plunger.

20. The valve assembly of claim 17, wherein the actuator further includes a return spring biasing the plunger toward the retracted position.
